(19) United States
(12) Patent Application Publication
(10) Pub. No.: US 2012/0137578 A1
(43) Pub. Date: Jun. 7, 2012

(54) APPARATUS FOR GROWING PLANTS

(76) Inventors: Christopher Branston Bradford, Cornwall (GB); Roy John O'Mahony, Wolrehampton (GB)

(21) Appl. No.: 13/203,613

(22) PCT Filed: Feb. 27, 2009
(86) PCT No.: PCT/GB2009/000569

§ 371 Date: Nov. 21, 2011

(51) Int. Cl. A01G 9/02

(52) U.S. Cl. 47/65; 47/65.5; 47/79

(57) ABSTRACT

An apparatus (6) for the cultivation of plants (10) is provided, the apparatus (6) comprising a track assembly (7,8,9,10); a plurality of support assemblies (5,6) mounted to the track assembly (7,8,9,10) so as to be moveable therealong; each support assembly comprising a receptacle for one or more plants (10), wherein the receptacle is removable from the apparatus. A growing room (2), such as a glasshouse or the like, comprising such an apparatus (6) is also provided.

The present invention relates to an apparatus for growing plants, including the culturing plants within a controlled environment, such as a glasshouse or the like.

It is well known to cultivate and grow plants of many different types and varieties in glasshouses and the like. The environment within the glasshouse may be controlled, in particular its temperature and humidity, to best favour the healthy growth of the plants. Such arrangements are used to produce plants commercially, including crops for food, flowers and the like. In addition, such glasshouses are used for the germination and hardening of many varieties of plants, prior to the plants being transferred to another location, typically outdoors.

A particular problem with glass houses is that the space within the glass house is used only inefficiently, with the portion of the space inside the glass house being occupied by the plants being grown being only very low. In addition, while sophisticated systems are often employed to provide feed and water to the plants, they are generally inefficient and result in a significant amount of the feed and water being wasted.

One approach to solving the aforementioned problems is disclosed in U.S. Pat. No. 6,173,529. This patent describes a plant growing room, in which a closed loop track is suspended above the floor and extends throughout the room. A plurality of racks are moveable along the track, each rack having a frame supporting a plurality of growing sheets for supporting and growing plants. The growing sheets are of a translucent material and are provided with a plurality of growing cells formed by lengths of membrane affixed to the growing sheet. The growing cells are gas permeable, liquid impermeable and translucent.

In use, plants are disposed with the growing cells. The racks are moved through the growing room along the track. The track is of a serpentine arrangement that extends through the growing room. The growing room described in U.S. Pat. No. 6,173,529 is provided with misters provided at spaced intervals along the track for misting the growing plant material, as it is moved through the growing room. The misters are provided with a solution that may contain such components as fertilizers, fungicides, insecticides and the like. The track and racks are arranged in the growing to maximise the use of the available space, in a preferred arrangement the racks on adjacent portions of the track are separated from each other by a distance of several inches. In order to allow workers to access individual growing cells, the track is provided with a portion having a screw section. The screw section is engaged by the racks as they approach along the track. The screw section is arranged to increase the space between adjacent racks, as they pass along the screw thread, allowing workers to access the growing cells.

There is a need for an improved system for the culturing and growing of plants, in particular within a glasshouse or other growing room. It would be advantageous if the system could maximise the use of the space within the glasshouse or growing room, while increasing the ability of workers to attend to the plants. In addition, it would be advantageous if the system could make efficient use of water and feed required to be provided to the plants, in particular minimising wastage of both.

In a first aspect, the present invention provides an apparatus for the cultivation of plants, the apparatus comprising:
a track assembly;
a plurality of support assemblies mounted to the track assembly so as to be moveable therealong;
each support assembly comprising a receptacle for one or more plants, wherein the receptacle is removable from the apparatus.

The apparatus of the present invention may be employed to cultivate plants retained in the receptacles in any suitable location. The apparatus is particularly suitable for use within a growing room, that is any room or facility in which plants are cultivated, propagated and grown, such as a glasshouse, greenhouse or the like.

The track is most preferably a closed track, such that the support assemblies may move and circulate around the track. In this way, the plants may be moved along the track and exposed to a range of different conditions of light intensity, temperature, humidity, and the like. This is particularly important when the apparatus is employed within a growing room, as the conditions within the room will vary from position to position. In such a case, plants in a fixed position within the growing room will vary in their growth, according to the conditions prevailing at the particular location of the plant within the room. This is particularly the case with light intensity, which can vary significantly within a growing room, such as a glasshouse or the like. By having the plants moved through the growing room along the track, all plants are exposed to the same range of conditions and thrive equally well under the prevailing conditions.

The track may extend in any suitable pattern. In one embodiment, the track is in the form of a simple circular or oval loop. However, it is preferred that the track extends through the space within which the apparatus is employed in order to maximise the use of the space. Accordingly, the track may have any suitable pattern that allows the maximum number of plants within the space available. One preferred pattern for the track is one comprising a plurality of substantially straight track portions connected at each end to adjacent track portions by a curved portion. A particularly preferred pattern for the track is a serpentine pattern. Other suitable track patterns will be apparent to the person skilled in the art.

The apparatus of the present invention further comprises a plurality of support assemblies that are connected to the track so as to be moveable therealong. The connection between the support assemblies and the track may be any suitable form of connection. For example, carriages may be provided to support the support assemblies and run along the track, with a carriage carrying one or more support assemblies. In a preferred embodiment, the track comprises a chain having a plurality of links and a guide for housing and supporting the chain. Support assemblies are connected to links in the chain, which is moved along the track by a suitable drive system. Each support assembly may be connected to and supported by a single link in the chain. More preferably, each support assembly is connected to and supported from a plurality of links in the chain. In one preferred embodiment, the track comprises a chain having a plurality of links, each link being provided with one or more wheels to bear against a track guide. The chain is preferably provided with the wheels rotatable about axes, such that the axes are at different angles, allowing the wheels to resist forces applied to the chain from a plurality of different directions. In a preferred arrangement, the chain comprises links having wheels rotatable about an axis extending in a first direction and links having wheels rotatable about an axis extending in a second direction perpendicular to the first direction.

Suitable drive systems for such a chain assembly are known in the art and available commercially.

The support assemblies are provided to support and carry one or more receptacles for plants, as described in more detail below. The support assembly may have any suitable form, which will be determined by the shape, configuration and number of receptacles to be carried. In one preferred arrangement, the support assemblies each comprise one or more rigid, substantially vertically extending frame members, to which the receptacles are attached by means of suitable brackets or the like. The support assemblies depend vertically from the track and may extend laterally either perpendicular to the longitudinal axis of the track or parallel to the longitudinal axis of the track, depending upon the arrangement of receptacles to be employed and the nature of the plants to be grown.

Some plants require a structure up which to climb and provide support. The support assemblies may be provided with suitable supporting members and/or of a suitable configuration to provide support for climbing plants.

As already noted, the apparatus of the present invention further comprises receptacles for plants. The receptacles are preferably removably mounted on the support assemblies, so as to be removable from the apparatus. Each support assembly may have mounted thereon a single receptacle or, more typically a plurality of receptacles. Single receptacles may be employed in the case of the cultivation of large plants that will be retained in the apparatus for a considerable time after initial germination and hardening. In order to provide the height necessary to allow the larger plants to grow and mature, the receptacle is mounted to the lower end of the support assembly at some distance from the track, such that the clearance between the receptacle and the track can accommodate the adult plant. In this way, the apparatus may be used not only to germinate and harden young plants, before being transplanted to a more permanent growing location, but also to allow mature plants to be cultivated, for example those that are grown to produce a crop, such as vegetables, flowers or fruit.

Alternatively, the support assemblies are provided with a plurality of receptacles for plants. The receptacles may be any suitable form and shape, appropriate for the cultivation and growth of the target plants. In a preferred embodiment, the receptacles are in the form of trays, in particular elongate trays, extending laterally across the support assemblies, most preferably perpendicular to the longitudinal direction of the track. The receptacles, in particular trays, may be stacked on the support assembly, for example by being supported on a vertical array of brackets extending from the support assembly. In one arrangement, each support assembly is provided with a single stack of receptacles, in particular trays, on one side. In an alternative arrangement, each support assembly is provided with a plurality of stacks of receptacles, in particular a stack of receptacles on each of two opposing sides of the support assembly.

It has been found that the packing density of the plants in a given arrangement and the number of plants that may be accommodated in a given growing room space is determined, in large part, by the spacing of adjacent support assemblies and receptacles along the track. While a close spacing will increase the number of support assemblies on a given length of track, it has been found that the radius of curvature of the curved portions of the track needs to be larger, in order to avoid the support assemblies, receptacles and plant foliage from contacting one another as the support assemblies pass around the curve in the track. A larger radius of curvature of the track bends, while allowing a lower spacing between adjacent support assemblies to be employed, increases the spacing between adjacent portions of the track, in turn reducing the density of plants that may be accommodated in the apparatus as a whole. In contrast, increasing the spacing between the adjacent support assemblies on the track allows a smaller radius of curvature to be used at the bends in the track, in turn allowing adjacent portions of the track to be closer together. Further, increasing the length of the receptacles in the direction lateral to the track increases the risk of contact between the receptacles of adjacent support assemblies at the bends and curves in the track. In general, for a given receptacle length, the support assemblies are preferably arranged to be as close as possible to one another, while avoiding the support assemblies making contact at the bends and curves in the track. It has been found that the use of a support assembly having two stacks of elongate receptacles extending perpendicular to the longitudinal axis of the track on opposing sides of the support assembly is a particularly efficient use of the available space, allowing a high plant density to be obtained, without damage to the plants or the apparatus itself.

In one preferred arrangement, the support assemblies having the elongate receptacles are supplemented by additional support assemblies disposed therebetween that have mounted on them receptacles that have a dimension lateral to the track that is less than the elongate receptacles. In this way, the space on the track between the support assemblies may be utilised, without increasing the risk of the receptacles contacting one another at the track bends and curves. In one preferred embodiment, support assemblies having elongate receptacles thereon have disposed therebetween additional support assemblies that support circular receptacles.

The receptacles are removable from the apparatus. This may be achieved by having each support assembly removable from the track. More preferably, each receptacle is removable from its respective support assembly. The receptacles may be designed to be removable in any suitable manner. In a particularly preferred embodiment, the receptacles are arranged to be removed laterally from the support assemblies in a direction that is substantially perpendicular to the longitudinal axis of the track and the direction of travel of the support assemblies, when the apparatus is in operation. In this way, the apparatus may be provided with a work station adjacent the track, from where workers may attend to the plants, removing them and replacing them as required, by first removing an entire receptacle from the apparatus. In this way, the apparatus may be kept in operation, with the support assemblies moving along the track, without interruption. In addition, this arrangement allows the use of such means as described in U.S. Pat. No. 6,173,529 to increase the distance between adjacent growing sheets in order to tend the plants in the growing cells.

In this respect, the present invention, in a further aspect, provides an apparatus for the cultivation of plants, the apparatus comprising:
a track assembly;
a plurality of support assemblies mounted to the track assembly so as to be moveable therealong, each support assembly comprising a receptacle for one or more plants; and
a work station adjacent the track from where plants in the receptacles may be tended;
in operation of the apparatus the support assemblies being moved continuously along the track assembly and wherein the distance between adjacent support assemblies along the track assembly is kept constant during operation.

Details of the apparatus of this aspect of the invention are as hereinbefore described.

As noted above, U.S. Pat. No. 6,173,529 discloses a system in which a plurality of misters are provided along the track, in order to dispense water and/or nutrients to the plants. It has been found that this arrangement may be inefficient in terms of its use of the water and nutrients and can result in significant wastage. It has further been found that the apparatus of the present invention may be provided with a single watering and feeding station at a single location along the track, through which the support assemblies are caused to pass during operation.

Accordingly, in a further aspect, the present invention provides an apparatus for the cultivation of plants, the apparatus comprising:
a track assembly;
a plurality of support assemblies mounted to the track assembly so as to be moveable therealong, each support assembly comprising a receptacle for one or more plants; and
a single station for providing water and/or nutrients to plants retained in the receptacles;
in operation the support assemblies being caused to pass through the station.

Details of the apparatus of this aspect of the invention are as hereinbefore described.

The watering and/or feeding station may comprise any suitable means for dispensing water and/or nutrients to the plants in the receptacles as the support assemblies pass through the station. In one arrangement, the station comprises one or more misters to dispense a mist of water, optionally containing one or more nutrients for the plants being cultivated. Suitable misters are known in the art and available commercially. The misters are of an arrangement as to dispense water and/or nutrients directly onto the foliage of the plants being cultivated and grown. By limiting the misters to a single station, it is possible to very accurately control the water and nutrients-being dispensed onto the plants and easily recover the excess water and nutrients that may run off the plants, for recycling and reuse. In a preferred embodiment, the watering and/or feeding station comprises a system for delivering water from a dispenser directly into each receptacle, as it passes through the station. In order to minimise the wastage of water and/or feed, the station is provided with a motion sensor that is triggered as a support assembly enters the station, activating the dispenser to provide a predetermined volume of water and/or feed to the receptacles. Most preferably, the dispenser is arranged such that each receptacle has one or more dedicated dispensing outlets, which deliver water and/or feed directly to that receptacle. In this way, the station may be arranged such that water and/or feed is provided to each receptacle and only when the receptacle is below the dispenser. It has been found that this system is particularly efficient in its use of water and feed, and provides minimal wastage.

Water and/or other liquids recovered in the watering and/or feeding station are preferably recycled and reapplied to the plants in the receptacles in the station. Liquids recovered and recycled in this manner are preferably treated to remove solids and other contaminants, for example by being fed to a settling tank, for removing dense contaminants, filtering, or the like. In addition, the liquids recovered are preferably treated to kill and microorganisms that may be present. Suitable means for treating the liquid streams in the manner are known in the art and include UV filters.

As noted above, during operation of the apparatus, plants are retained in the receptacles, together with a suitable plant growth medium, as may be appropriate and desired. The receptacles are loaded onto the support assemblies, which are then moved along the track by a suitable drive means. In the preferred embodiment, the support assemblies are moved continuously in a single direction along a closed track. The support assemblies are caused to pass through a single watering and/or feeding station, in which the plants are provided with water and/or nutrients, as may be required. Further, the apparatus is provided with a work station adjacent the track, from which receptacles may be removed from the apparatus, most preferably by being removed laterally from their respective support assembly, allowing the plants in the receptacles to be tended to away from the apparatus, and without interrupting the movement of the support assemblies along the track.

In operation, the support assemblies are moved along the track at a speed that is determined, in part, by the nature and variety of the plants being grown and the environment in which the apparatus is operated. Typical speeds for movement of the support assemblies along the track are from 0.1 to 5 m/min, preferably from 0.2 to 2.5 m/min, more preferably from 0.4 to 1.5 m/min. A speed of about 1 m/min has been found to be suitable for many plants and environments.

In a further aspect, the present invention provides a growing room comprising an apparatus as described hereinbefore.

In this respect, the term ‘growing room’ is a reference to any partially or wholly enclosed space within which the apparatus may be installed and operated to cultivate plants. As noted, examples of growing rooms are greenhouses and glass houses. The growing room may be provided with means for controlling the environment within, in particular controlling the temperature and humidity. The growing room may be provided with natural light, as in the case of a glasshouse. Alternatively, or in addition thereto, the apparatus of the present invention may comprise means for providing artificial light to the plants as they are moved.

Embodiments of the present invention will now be described, by way of example only, having reference to the accompanying drawings, in which:

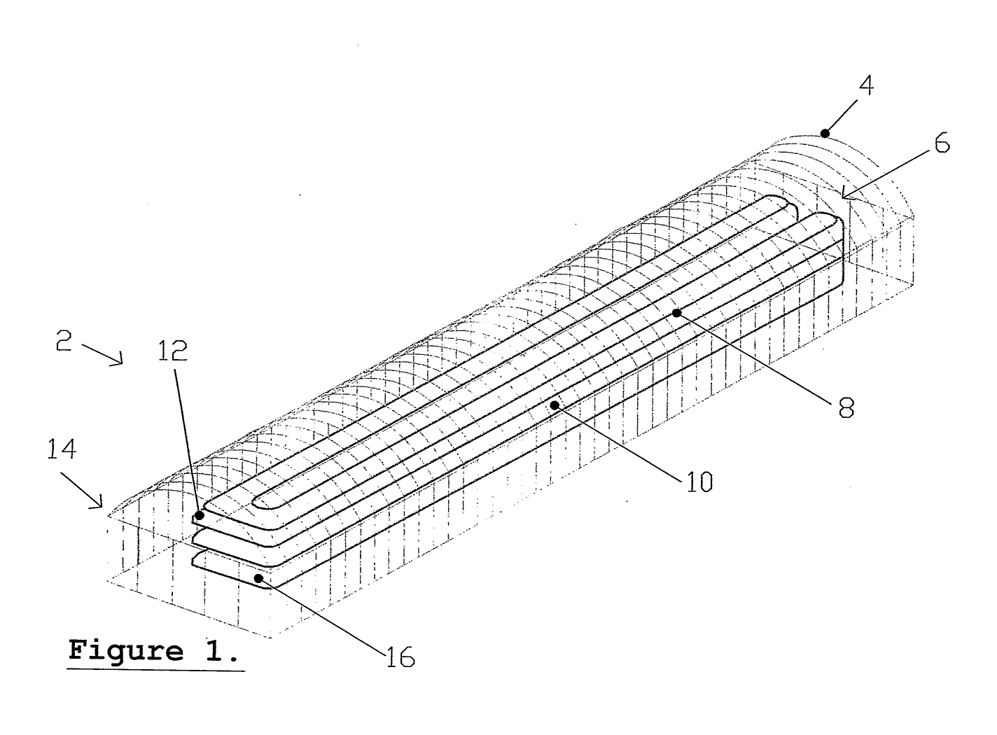

FIG. 1 is a perspective view of one embodiment of a growing room according to the present invention;

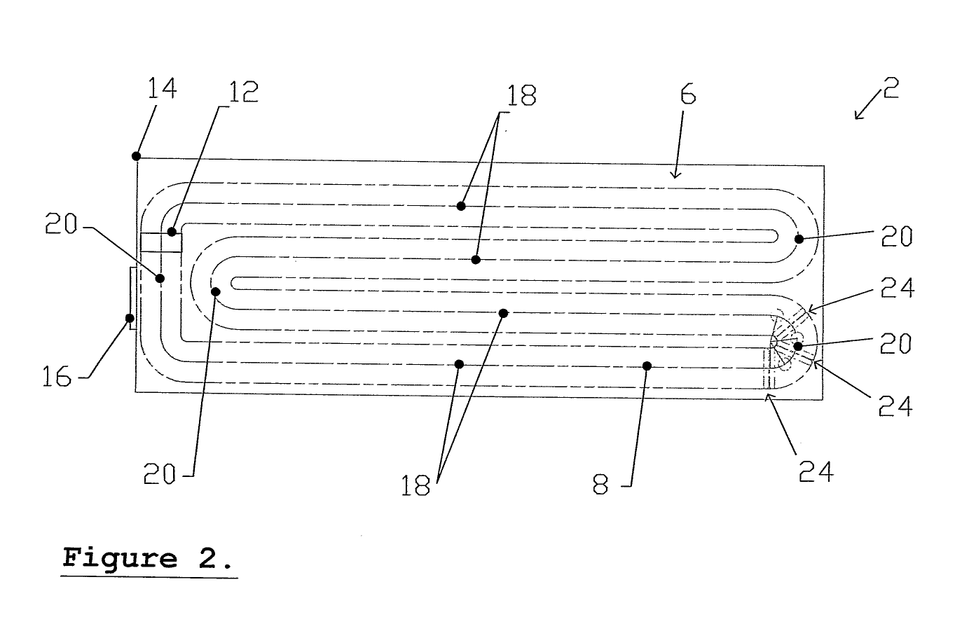

FIG. 2 is a plan view of the interior of the growing room of FIG. 1 showing the layout of the track assembly;

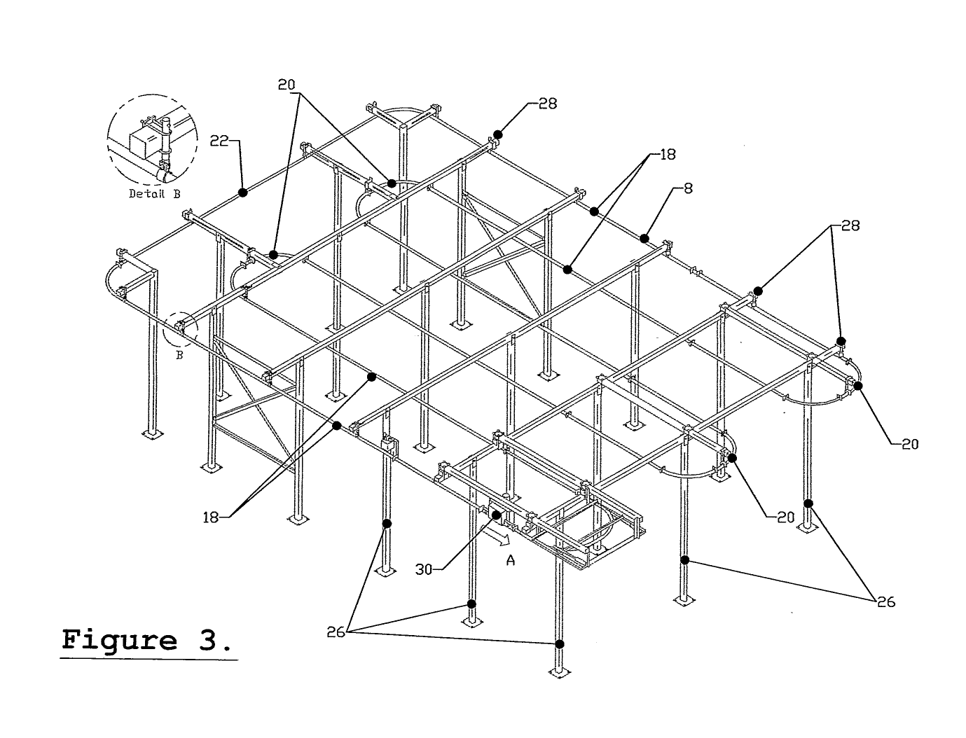

FIG. 3 is a perspective view of the track assembly of FIG. 2;

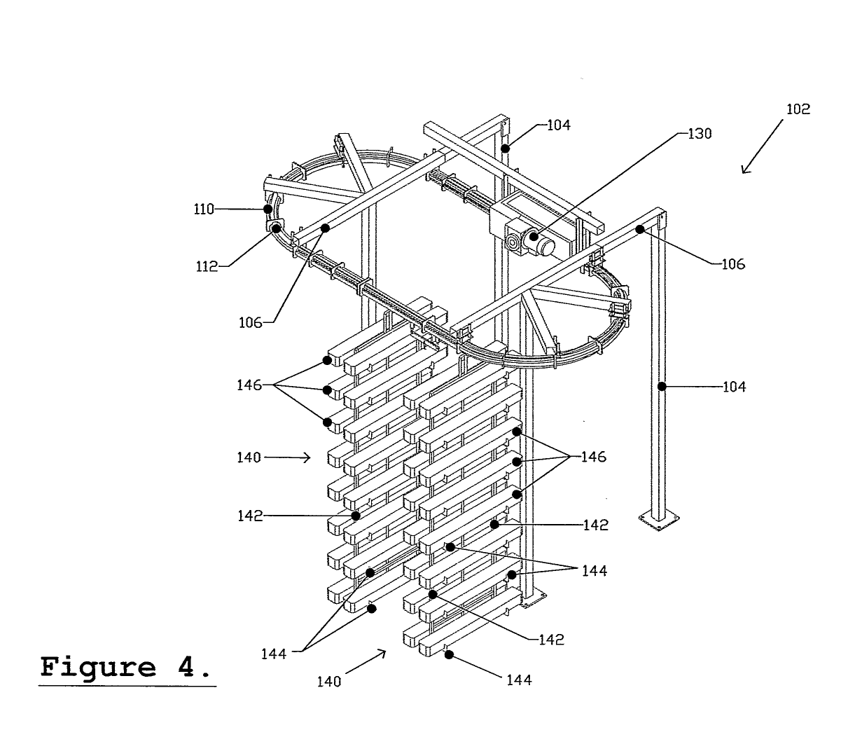

FIG. 4 is a perspective view of an apparatus according to a second embodiment of the present invention;

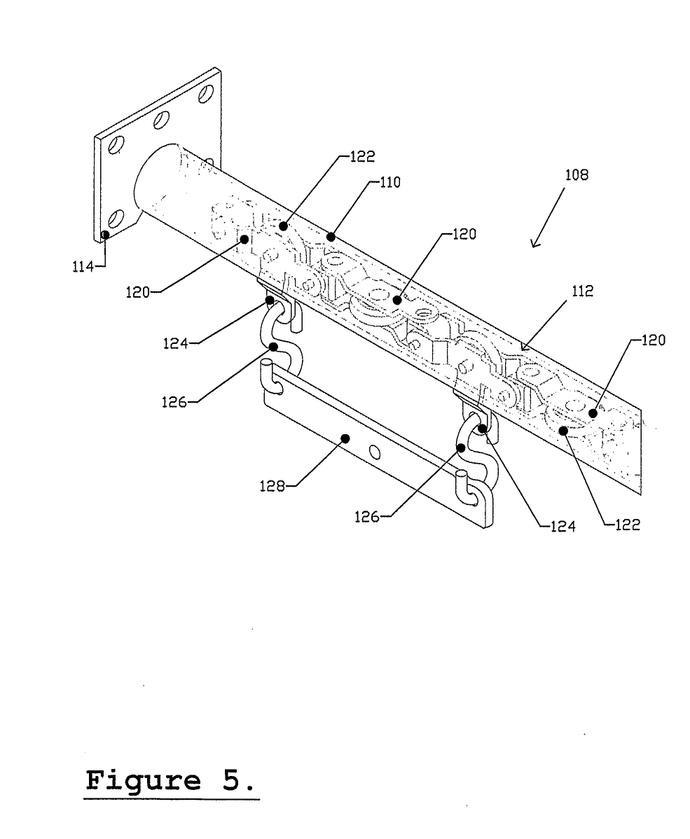

FIG. 5 is a perspective view of the track assembly of the apparatus of FIG. 4;

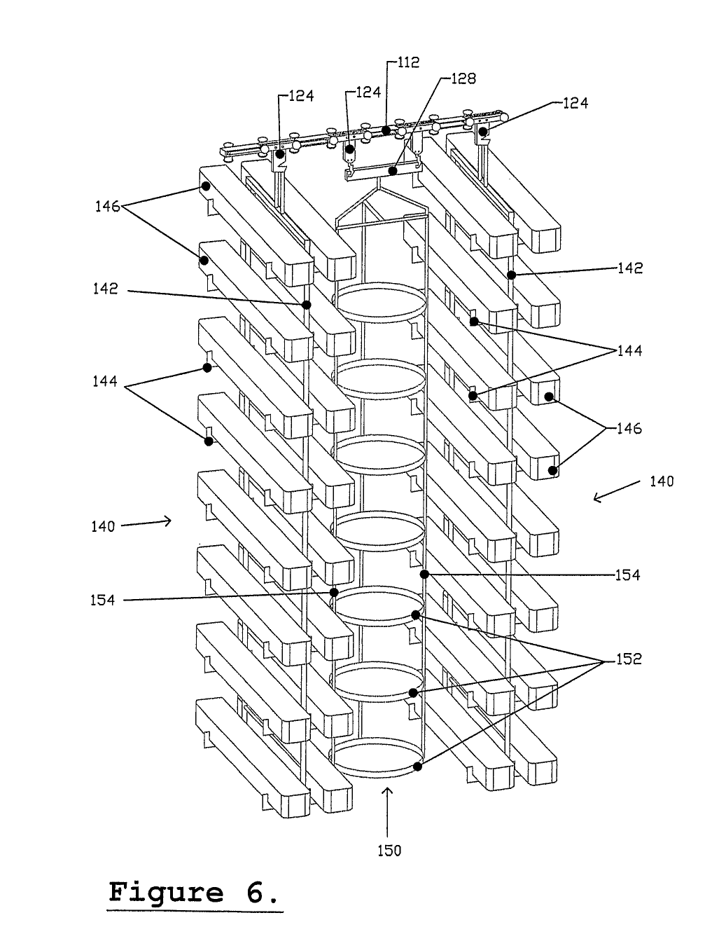

FIG. 6 is a perspective view of an alternative support assembly for use with the apparatus of FIG. 4;

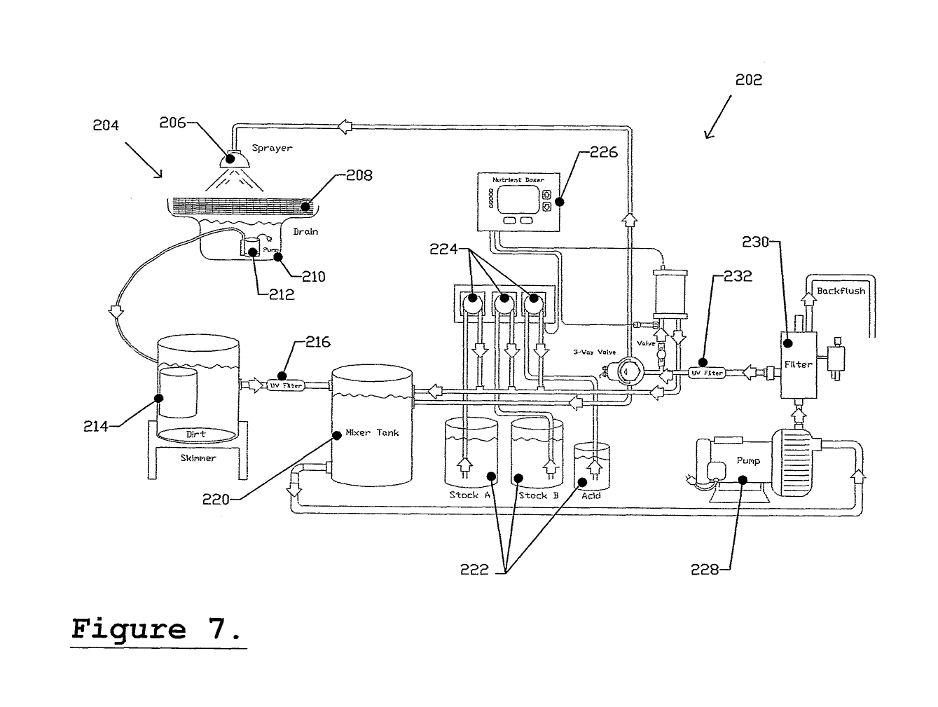

FIG. 7 is a schematic representation of a system for providing water and nutrients to plants in the watering/feeding station of the apparatus of the present invention; and

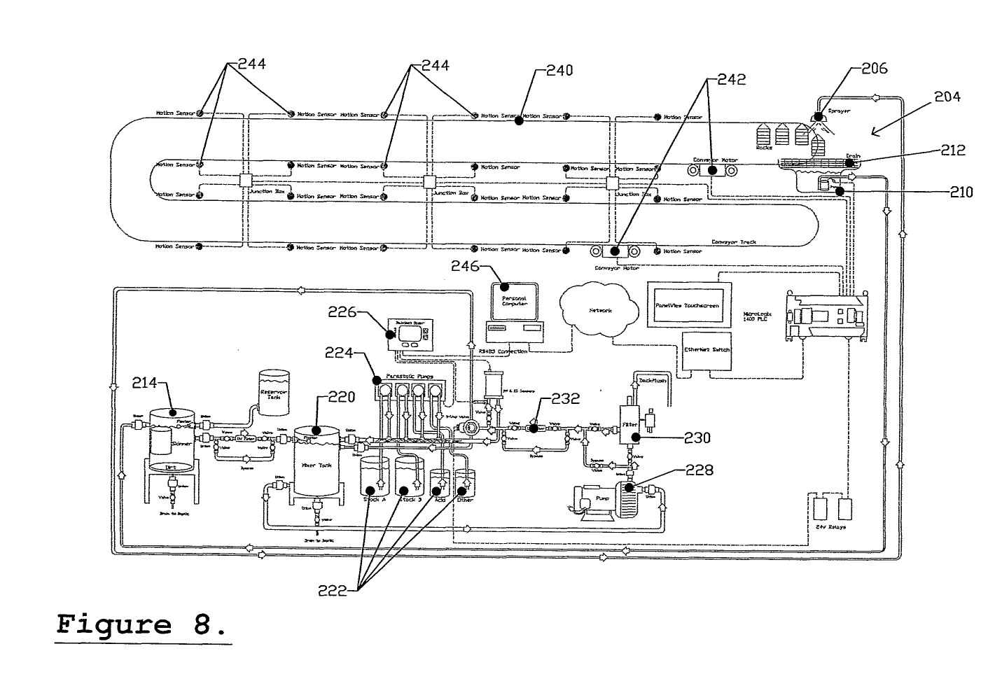

FIG. 8 is a schematic representation of an apparatus of the present invention showing the integration of the track assembly and the system of FIG. 7.

Referring first to FIG. 1, there is shown a growing room of one embodiment of the present invention housing an apparatus of the present invention. The growing room, generally indicated as 2, is in the form of a glass house having a curved transparent roof 4. As shown in FIG. 1, an apparatus, generally indicated as 6, is disposed within the glass house and has a closed track 8 extending in a generally serpentine pattern. Plants 10 are supported on support assemblies (not visible in FIG. 1) moveable along the track 8. The arrangement of the apparatus is such that substantially all of the interior of the glass house is filled with plant foliage, thereby maximising the use of the growing room. A watering/feeding station 12 is disposed at one end 14 of the glass house, together with a workstation 16, by means of which workers may tend the plants growing within the glass house as they pass along the adjacent portion of the track 8.

Referring to FIG. 2, there is shown a plan view of the interior of the glass house of FIG. 1, indicating the general layout of the track 8. As shown more clearly in FIG. 2, the track has a generally serpentine arrangement, that is has a plurality of straight portions 18 extending longitudinally within the glass house and parallel to one another. The respective ends of the adjacent straight portions are connected by curved portions 20. A further straight portion 22 extends laterally across the end 14 of the glass house and is provided with the watering/feeding station 12 and the work station 16. A plurality of support assemblies and receptacles, generally indicated as 24, are shown in FIG. 2 negotiating one curved portion of the track 8.

A perspective view of the track assembly of FIG. 2 is shown in FIG. 3. As shown, the track 8 is supported on a support structure comprising a plurality of posts 26 and cross members 28. The track 8 comprises a chain having links, to which are mounted the support assemblies, as will be described in detail below. A motor 30 provides drive for the chain to move it and the support assemblies along the track 8 in the direction of the arrow A.

It is to be understood that the track arrangement shown in FIGS. 1 to 3 is just one example of a great many track patterns that may be employed with the apparatus of the present invention. The particular pattern of the track may be selected to suit the space or room in which the apparatus is to be operated, so as to maximise the number of plants to be accommodated in the space available.

Turning to FIG. 4, there is shown an apparatus according to a further embodiment of the present invention, generally indicated as 102. The apparatus 102 comprises a plurality of vertical support posts 104 and cross members 106 supporting a track 108. The track 108 is a closed track of a generally oval configuration. The track 108 comprises a track guide 110 in which extends a chain assembly 112, shown in more detail in FIG. 5. The track guide 110 is generally tubular, extending along the path of the track 108 and supported by brackets 114 extending from the cross members 106. The track guide 110 has a longitudinal slot extending in its lower side along its entire length. The chain assembly 112 comprises a plurality of chain links 120, each link having a wheel 122 that is free to rotate and bear upon the inner surface of the track guide 110, in order to ensure that the chain is free-running. The wheels 122 of adjacent links are mounted to rotate about axes that are perpendicular to one another, to prevent both lateral and vertical forces reducing the freedom of the chain to move within the track guide 110. Brackets 124 extend vertically downwards from the chain links 120, in particular those links with wheels rotating about a horizontal axis; and extend through the slot in the track guide and provide a means for attaching a support assembly to the chain assembly. As shown in FIG. 5, hooks 126 releasably attach the upper member 128 of the support assembly to the chain assembly.

Referring again to FIG. 4, the chain assembly 112 is moved along the track guide 110 by a motor 130, providing drive to the chain assembly through a suitable transmission and a sprocket (not shown for clarity).

Shown in FIG. 4 is a pair of support assemblies, generally indicated as 140, suspended from the chain assembly 112 of the track 108. Each support assembly 140 comprises a vertically extending support frame 142, extending laterally perpendicular to the longitudinal axis of the track 108 and from which extend a plurality of brackets 144. Each support frame 142 is connected to a respective bracket 124 extending downwards from the chain assembly 112 in the track 108. Receptacles for plants in the form of elongate trays 146 are supported by the brackets 144 and extend horizontally perpendicular to the longitudinal axis of the track 108. The trays 146 are arranged in vertical stacks containing a plurality of trays. As shown in FIG. 4, each support assembly is provided with two stacks of trays 146, one on each opposing side of the support frame 142. It has been found that this arrangement is particularly efficient in utilising the available space and allowing an optimum combination of spacing between adjacent support assemblies 140 and the radius of curvature of the curved portions of the track to be employed.

Each tray 146 rests on the brackets 144 supporting it and thus may be easily removed from the support assembly, in particular by being slid laterally out of the support assembly in a direction parallel to the support frame and perpendicular to the longitudinal axis of the track 108.

The trays 146 are arranged to contain plants being cultivated and suitable growth medium, as appropriate.

The arrangement of the trays 146 shown in FIG. 4 is just one of many such arrangements that may be employed. The number and spacing of the trays in a given support assembly will be determined by the nature of the plants being cultivated and grown. In particular, the arrangement shown in FIG. 4 may be suitable for the germination and hardening of plants, after which they are removed and transplanted to a different growing location to mature. Fewer trays with a larger vertical spacing than that shown may be used for plants that have bulkier foliage or that are to be retained in the apparatus to a more mature stage. A stack may have a single tray disposed at the bottom of the support frame in the case that climbing plants are to be grown and allowed to mature, for example to provide a crop of fruit or vegetables. The support frame may be provided with supports for the foliage of plants such as climbing plants, for example in the form of a mesh, lines, or other support members, as appropriate.

Turning to FIG. 6, there is shown an alternative support assembly arrangement for use with the apparatus of the present invention, such as the embodiment shown in FIG. 4. The support assembly arrangement comprises a pair of support assemblies 140 of the configuration shown in FIG. 4 and described hereinbefore. Between the two support assemblies 140 is an alternative support assembly arrangement, generally indicated as 150. The support assembly arrangement 150 is adapted to house larger or more mature plants and comprises a plurality of circular trays 152 supported on vertical frame members 154, in turn connected to an upper support member 128, as shown in FIG. 5. Again, the number and orientation of the trays 152 may be varied according to the size and needs of the plants being grown.

As described hereinbefore, the apparatus of the present invention comprises a watering and/or feeding station, through which the support assemblies are caused to pass. One embodiment of system for supplying a watering and feeding station is shown schematically in FIG. 7. The system, generally indicated as 202, operates in conjunction with a watering/feeding station 204 that is disposed adjacent the track of an apparatus of the present invention. The watering/feeding station 204 comprises a sprayer or mister 206 to provide a spray or mist of water and/or a solution of nutrients to the plants as they pass through the station. Run off is collected in a drain 208 having a sump 210 in which is disposed a return pump 212, pumping liquid in the sump to a settling tank 214, in which dirt is allowed to settle and be removed. Cleaned liquid is removed from the settling tank 214, is treated in a UV filter 216 to kill any microorganisms and is returned to a mixer tank 220.

The mixer tank 220 is provided with the recycled liquid, as described above, and a fresh feed of water and nutrients. Tanks 222 contain components to make up a liquid feed suitable for the plants being cultivated. The components are removed from the tanks 222 by peristaltic pumps 224 under the control of a processor 226 to provide the requisite amounts to the mixer tank 220. A feed pump 228 provides the liquid mixture from the mixer tank 220 to the watering/feeding station 204 via a filter 230 and an UV filter 232.

The integration of the watering and feeding system 202 of FIG. 7 within the overall apparatus is illustrated schematically in FIG. 8. The watering/feeding station 204 is shown disposed on one curved section of a track 240. The track is provided with two motors 242 for driving the chain assembly of the track. An array of motion sensors 244 is disposed about the track to provide data regarding movement of the support assemblies and the plants contained therein. Data is received from the motion sensor array by a central processor 246, which in turn controls the operation of the motors 242, the watering/feeding system. The processor 246 may be located in the apparatus, for example adjacent the track. Alternatively, the processor 246 may be remote from the apparatus and connected to the various components to receive and transmit data by means of a network.

The watering/feeding station comprises a dispensing system activated by motion sensors disposed in the station. As a receptacle enters the station, its presence is detected by the respective motion sensor and the dispensing system is activated. The dispensing system comprises outlets for water and feed disposed immediately above the position of each receptacle. Upon activation by the motion sensors, a valve, such as a solenoid valve, is opened in the line corresponding to the respective receptacle and water/feed is dispensed. The volume of liquid dispensed in this manner may be preset in the system, such that the valve is closed once the predetermined volume has been dispensed. Alternatively, the valve may closed upon activation by a further motion sensor positioned to detect when the receptacle moves out of position under the respective outlet.

1. An apparatus for the cultivation of plants, the apparatus comprising:
a track assembly;
a plurality of support assemblies mounted to the track assembly so as to be moveable therealong;
each support assembly comprising a receptacle for one or more plants, wherein the receptacle is removable from the apparatus.

2. The apparatus according to claim 1, wherein the track assembly is a closed track assembly.

3. The apparatus according to claim 2 wherein the track assembly comprises a plurality of straight track portions, each connected to adjacent straight track portions by curved track portions.

4. The apparatus according to claim 3, wherein the track assembly extends in a serpentine pattern.

5. (canceled)

6. The apparatus according to claim 1 wherein the track assembly comprises a chain moveable along the track assembly; and the track assembly further comprises a track guide in which the chain runs.

7. (canceled)

8. The apparatus according to claim 6 wherein the chain comprises links having wheels rotatable about an axis extending in a first direction and links having wheels rotatable about an axis extending in a second direction perpendicular to the first direction; the wheels bearing against the track guide.

9. The apparatus according to claim 1 wherein the support assemblies comprise one or more rigid, substantially vertically extending frame members, the receptacles being mounted to the said frame members.

10. The apparatus according to claim 9, wherein the receptacles are releasably mounted to the frame members.

11. (canceled)

12. The apparatus according to claim 1 wherein one or more of the support assemblies comprise supports for supporting the foliage of climbing plants.

13. The apparatus according to claim 1 wherein the support assemblies are releasably connected to the track assembly.

14. The apparatus to claim 1 wherein each support assembly has mounted thereon a plurality of receptacles each configured to hold one or more plants.

15-16. (canceled)

17. The apparatus according to claim 14 wherein the track assembly has a longitudinal axis; and the receptacles are in the form of elongate trays which extend perpendicular to the longitudinal axis of the track assembly.

18. The apparatus according to claim 17, wherein each support assembly is provided with a stack of the trays; and the trays are removable respectively from the support assemblies.

19. The apparatus according to claim 17 wherein each support assembly is provided with two stacks of the trays, the stacks being arranged on opposing sides of the support assembly.

20. The apparatus according to claim 17 wherein the trays are removable laterally from the apparatus in a direction substantially perpendicular to the longitudinal axis of the track assembly.

21. (canceled)

22. The apparatus according to claim 1 further comprising a single watering and/or feeding station, through which the support assemblies are caused to pass when being moved along the track assembly.

23. The apparatus according to claim 20 wherein the distance between adjacent support assemblies along the track is fixed along the entire length of the track.

24. (canceled)

25. The apparatus according to claim 1 further comprising a station which comprises a dispensing system for delivering water and/or feed to the receptacles, the dispensing system being activated by the movement of the receptacles into and/or out of the station.

26. (canceled)

27. An apparatus for the cultivation of plants, the apparatus comprising:
a track assembly;
a plurality of support assemblies mounted to the track assembly so as to be moveable therealong, each support assembly comprising a receptacle for one or more plants; and
a work station adjacent the track from where plants in the receptacles may be tended;
in operation of the apparatus the support assemblies being moved continuously along the track assembly and wherein the distance between adjacent support assemblies along the track assembly is kept constant during operation.

28. An apparatus for the cultivation of plants, the apparatus comprising:
a track assembly;
a plurality of support assemblies mounted to the track assembly so as to be moveable therealong, each support assembly comprising a receptacle for one or more plants; and
a single station for providing water and/or nutrients to plants retained in the receptacles;
in operation the support assemblies being caused to pass through the station.

29. (canceled)
